(19) United States
(12) Patent Application Publication
(10) Pub. No.: US 2013/0199515 A1
(43) Pub. Date: Aug. 8, 2013

(54) SKYLIGHT ENERGY MANAGEMENT SYSTEM

(71) Applicant: MBC VENTURES, INC., Baltimore, MD (US)

(72) Inventor: John Joseph Tandler, Arvada, CO (US)

(73) Assignee: MBC VENTURES, INC., Baltimore, MD (US)

(21) Appl. No.: 13/749,053

(22) Filed: Jan. 24, 2013

Related U.S. Application Data
(60) Provisional application No. 61/589,933, filed on Jan. 24, 2012.

(51) Int. Cl. F24J 2/04; E06B 9/02; F24J 2/46; E04D 13/035; F24J 2/34

(52) U.S. Cl. CPC F24J 2/0433; E04D 13/0351; F24J 2/345; F24J 2/46; E06B 9/02
USPC 126/623; 126/628; 126/640; 126/702

(57) ABSTRACT

Disclosed is a system and method for harvesting solar energy, and more particularly an energy-positive sky lighting system that may provide an integrated energy solution to a variety of commercial buildings. A plurality of skylight modules are provided, each having a plurality of louvers configured to reflect incoming sunlight onto a thermal receiver area on an adjacent louver to heat a working fluid in communication with the louvers (i.e., such that heat transfer is carried out between the thermal receiver and the working fluid), all while allowing control of the amount of daylight that passes through the module. The modules are constructed such that the balance of the solar energy not going into day lighting is captured in the form of thermal heat, which in turn may be applied to building system cooling and heating applications.

### CROSS REFERENCE TO RELATED APPLICATION

This application is based upon and claims benefit of copending U.S. Provisional Patent Application Ser. No. 61/589,933 entitled “Skylight Energy Management System,” filed with the U.S. Patent and Trademark Office on Jan. 24, 2012 by the inventor herein, the specification of which is incorporated herein by reference.

### FIELD OF THE INVENTION

This invention relates to radiant energy management, and more particularly to systems for capturing solar energy to manage illumination and temperature within a defined space.

### BACKGROUND OF THE INVENTION

Solar generation and cogeneration systems can offer a logical alternative or addition to fossil fueled energy systems as fuel costs and environmental concerns increase. The solar heat that is collected in a collection system, with or without electricity (such as by way of photovoltaic cells), may provide a major boost to an energy system's value. Unfortunately, however, “solar cogeneration” systems need to be located at the site of use, which presents challenges to most existing or previous concentrator methods. Because the collected heat generally is at low temperature (e.g., typically 40-80 degrees C.), the heat energy cannot be transmitted far without substantial parasitic losses. Further, the capital cost of hot water and other heat transmission systems favors direct on-site use. And, such low temperature heat generally cannot be converted in a heat engine to mechanical or electrical power because of the small temperature differential versus ambient temperatures. Accordingly, systems are needed that harvest light energy and transfer the harvested energy easily to the heating requirements at the site of use, such that the immediate needs of the site are factored into how the system is controlled.

Solar cogeneration technologies are, in part, held back by challenges in creating optical systems that are both inexpensive and that can be mounted or integrated into a building. One problem is the practical limit for how tall a design can be to withstand forces from windy conditions on the device and building on which it may be mounted. Tying a cogeneration apparatus into the foundation or load bearing structure of a building creates expensive installations and/or mounting systems to accommodate system stresses, particularly on the roof. Many commercial sites lack sufficient ground space for a reasonably sized system, and roof-mounting is the only viable option to obtain sufficient collector area.

Efforts have been made to meet the foregoing challenges. For instance, MBC Ventures, Inc., the assignee of the instant application, has developed solar harvesting apparatus and methods and their incorporation into building structures, as described in co-owned U.S. Patent Publication No. US2009/0173375 titled “Solar Energy Conversion Devices and Systems” (U.S. application Ser. No. 12/349,728), and co-owned U.S. Patent Publication No. US2011/0214712 titled “Solar Energy Conversion” (U.S. application Ser. No. 13/056,487), both of which specifications are incorporated herein by reference in their entireties. While such systems provide significant improvement over prior solar harvesting systems, opportunities remain to enhance the reliability, reduce cost, and improve the performance of such systems.

### SUMMARY OF THE INVENTION

Disclosed is a system and method for harvesting solar energy, and more particularly an energy-positive skylighting system that may provide an integrated energy solution to a variety of commercial buildings. A plurality of skylight modules are provided, each having a plurality of louvers configured to reflect incoming sunlight onto a thermal receiver area on an adjacent louver to heat a working fluid in communication with the louvers (i.e., such that heat transfer is carried out between the thermal receiver and the working fluid), all while allowing control of the amount of daylight that passes through the module. The modules are constructed such that the balance of the solar energy not going into daylighting is captured in the form of thermal heat, which in turn may be applied to building system cooling and heating applications.

With regard to one aspect of a particularly preferred embodiment of the invention, an energy management system is provided, comprising a skylight module, a first louver having a front side and positioned within the skylight module, a second louver having a back side and positioned adjacent the first louver within the skylight module such that the back side of the second louver faces the front side of the first louver, and a receiver tube fixedly mounted within the skylight module, the receiver tube having an outer surface comprising a thermal collector and an interior fluid channel, and the second louver being pivotably attached to the receiver tube, wherein the front side of the first louver is configured to reflect sunlight impacting the front side of the first louver toward the back side of the second louver, and the thermal collector is configured to convert at least a portion of the reflected sunlight into thermal heat and transfer the thermal heat to a working fluid within the interior fluid channel.

With regard to another aspect of a particularly preferred embodiment of the invention, an energy management system is provided, comprising a first louver having a front side, a second louver having a back side and positioned adjacent the first louver such that the back side of the second louver faces the front side of the first louver, a receiver tube attached to the back side of the second louver, the receiver tube having an outer surface comprising a thermal collector and an interior fluid channel, and a reflecting diffuser attached to the back side of the second louver, wherein the front side of the first louver is configured to reflect sunlight impacting the front side of the first louver toward the back side of the second louver, the thermal collector is configured to convert at least a portion of the reflected sunlight into thermal heat and transfer the thermal heat to a working fluid within the interior fluid channel, and the reflecting diffuser is configured to reflect at least a portion of the reflected sunlight to a space below the first and second louvers.

### BRIEF DESCRIPTION OF THE DRAWINGS

The numerous advantages of the present invention may be better understood by those skilled in the art by reference to the accompanying drawings in which:

FIG. 1 is a perspective view of a skylight module in accordance with an aspect of a particularly preferred embodiment of the invention.

FIG. 2 is a front, top perspective view of the skylight module of FIG. 1.

FIG. 3 is a perspective view of a louver assembly for use with the skylight module of FIG. 1.

FIG. 3a is a schematic side view of various operational modes of the louver assembly of FIG. 3.

FIG. 4 is a side perspective sectional view of two louvers for use with the louver assembly of FIG. 3.

FIG. 5 is a side view of a thermal receiver tube.

FIG. 6 is close-up view of one of the louvers of FIG. 4.

FIG. 7 comprises graphs showing relevant design parameters for the mirrors used in the louvers of FIG. 4.

FIG. 8a through 8e provide schematic side views of various operational modes of the louver assembly of FIG. 3.

FIG. 9 provides a perspective view and a schematic view of a flow path of fluid through the skylight module of FIG. 1.

FIG. 10 is a front, top perspective view of the skylight module of FIG. 1 showing placement of sections of diffuse material.

FIG. 11 is a graph showing sun angle for various times of year.

FIG. 12 is a perspective view of a sky sensor for use with the skylight module of FIG. 1.

FIG. 13 is a schematic view of a prior art thermal storage system.

FIG. 14 is a sectional view of a working fluid thermal storage system in accordance with an aspect of a particularly preferred embodiment of the invention.

FIG. 15 is a schematic view of the working fluid thermal storage system of FIG. 14 comprising multiple storage tanks

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

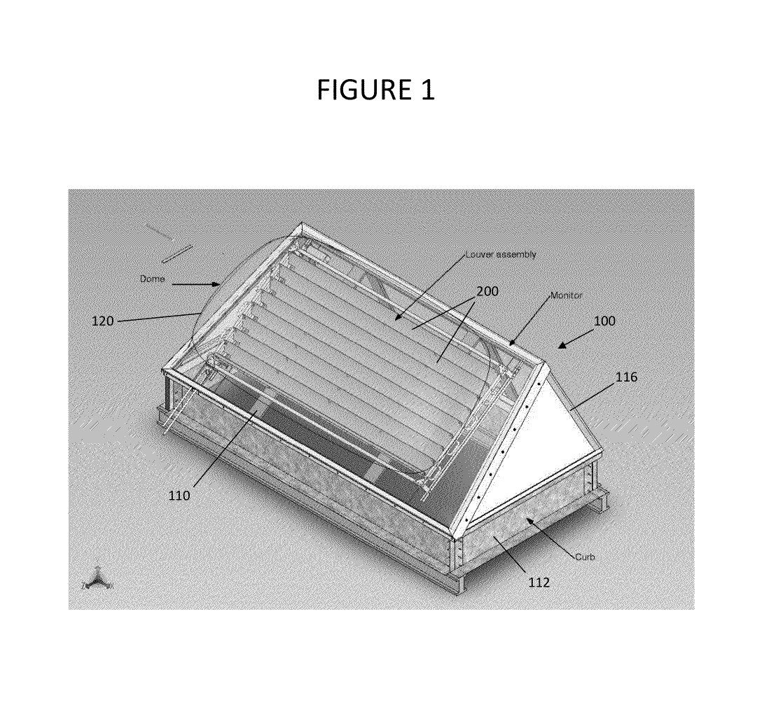

FIG. 1 shows a perspective view of a skylight module (shown generally at 100) in accordance with certain aspects of an embodiment of the invention, the module being configured for installation in, for instance, the roof of a building, such as a commercial building. The module is configured to provide approximately 50-70 percent more daylighting than standard daylighting solutions, as well as generating thermal heat at temperatures of up to 300 F. This is accomplished by providing a higher skylight to floor ratio (SFR) than typical skylight installations. The larger aperture is used to provide full interior illumination during cloudy, morning and afternoon periods. As further detailed below, the solar energy that is in excess of that required for illumination is captured by a single axis micro-concentrating collector embedded in the skylight, making the energy available to offset building thermal loads while relieving the building cooling system of the solar heat load that would be coming through such a large roof opening.

In prior constructions, a module might have two operational modes. In such embodiment, when the level of direct beam solar radiation incident on the module is above a threshold value, the module would enter a tracking mode. In this mode, all of the direct solar radiation that falls on the louver assembly may be focused on the thermal receiver area on the back of the adjacent louver. In this case, day lighting is provided primarily by transmissive light-diffusing surfaces around the perimeter of the louver assembly and on the east, west, and north walls of the monitor (the module being installed on a building surface such that the louvers face south for installations in, for example, North America, so as to face the sun). Secondarily, some diffuse light also passes between the louvers, especially at low sun angles. When the amount of direct solar radiation falls below the threshold for tracking mode, the module enters day lighting mode, and the louvers are opened fully. A night mode could also be provided, when the louvers shut completely to reduce the thermal heat loss and the leakage of light to the night sky. Consequently, in this embodiment, when the module is in tracking mode, there may be no means to modulate or control the amount of daylighting delivered by the module. The sizing of an installation in this case is generally done based on the amount of illumination required by the space beneath, so consequently the amount of thermal energy produced by a system is not a separate variable that the system designer can manipulate. This means that in some cases, there may be an excess of thermal energy available, and in other cases, conventional solar thermal modules are needed to supplement the heat provided by the modules. Also with regard to this embodiment, the lighting levels in the space would not be tailored to the needs of the activity in the space, nor would the split of energy going into day lighting and thermal uses be varied. This may result in overlighting the space when unoccupied or when the use of the space otherwise does not require full illumination. This over-illumination may add significantly to heat load that the building's cooling systems must handle, and also represents a lost opportunity to capture thermal heat for useful purposes.

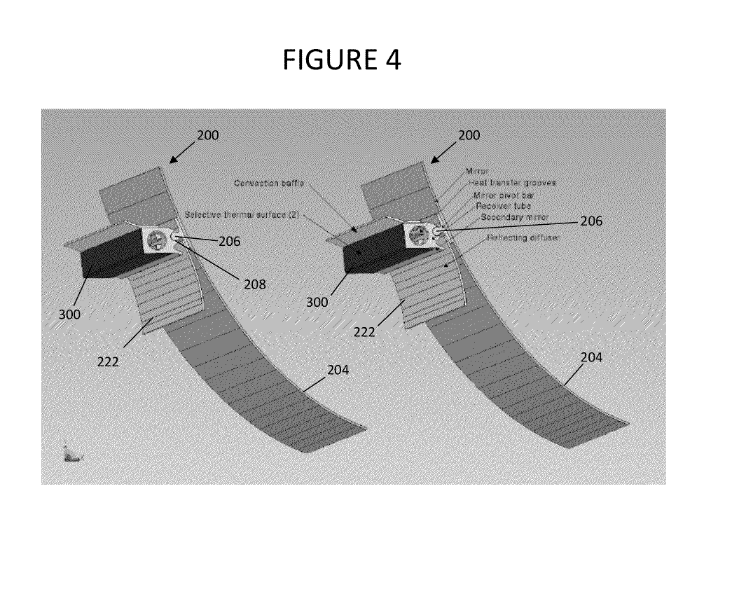

In an improved design, the louvers of a module include a planar thermal receiver 300 (FIG. 4) on the back of the louvers that is preferably relatively small in size, such that it is possible to have a high degree of focus of the mirror system. A small thermal receiver (as described herein) has a proportionally reduced heat dissipation rate for the same heat input, and thus increases the efficiency of the thermal collection, and consequently increases the peak collection temperatures up to about 220 F. The heat collected from such assembly may be put to various uses, including service water heating, space heating, and some process heat applications including driving single effect absorption chillers for air conditioning.

With particular regard to the embodiment shown in FIG. 1, an improved design provides the means to seamlessly vary the amount of lighting delivered by each skylight module 100 in real time, with the balance of the solar energy not going into daylighting being captured in the form of thermal heat, as further detailed below. Moreover, and again with particular regard to the embodiment shown in FIGS. 1 and 4, louvers 200 may be provided with a thermal receiver 300 that increases the collection temperature to the range of 275 F to 300 F, thus providing more high-value applications of the heat, such as double effect chillers with up to double the cooling value per unit of heat input, and also power generation using organic Rankine cycle or Kalina cycle turbine/generator systems. Alternatively, improving the collection efficiency in the 200-220 F range greatly improves the economics of thermal process heat applications such as single effect chillers. As further detailed below, the design shown in the embodiment of FIG. 1 incorporates improved optics which provides a concentration ratio of 10 to 15, resulting in a smaller thermal receiver area and temperatures high enough to drive these higher value loads, and greater efficiency at lower temperatures. Being able to drive loads that provide efficient cooling and power generation vastly expands the number of applications for the system, because many more buildings have need for cooling and power than more application-specific process heat uses.

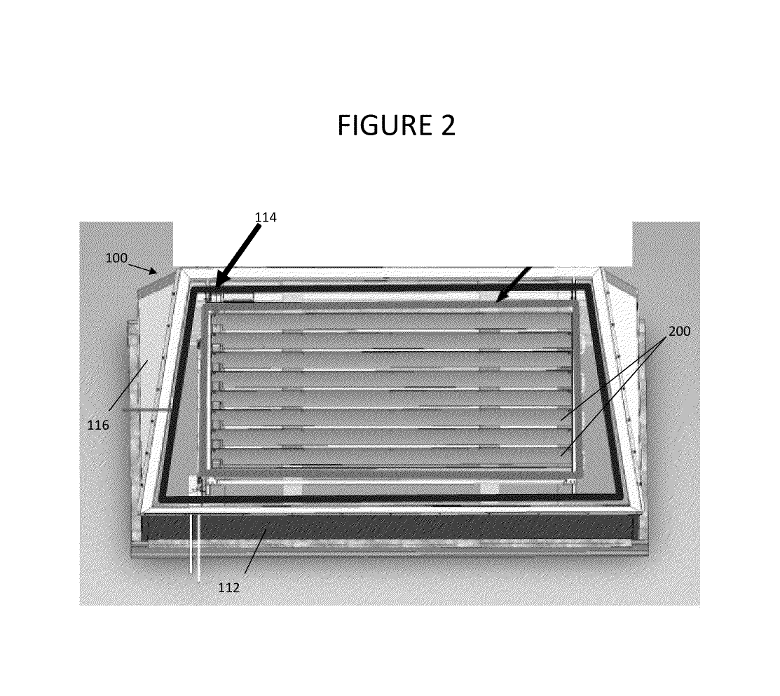

In order to maximize flexibility in the utilization of the solar resource, it is desired to have the louvers 200 cover a larger fraction of the south-facing wall 110 of the module 100. When light is required, the position of louvers 200 can be adjusted to produce more daylight, but when the daylight is not desired, the energy can be captured as thermal heat rather than directing excess illumination to the space below. As shown in FIG. 2, the trapezoidal shape of the skylight module 100 is driven by two practical requirements. First, the shape of the curb 112 should be rectangular for ease of integration with an existing roof structure. Second, the trapezoidal shape of the skylight modules allows them to be stacked for efficient shipping volume. Therefore, for the louver assembly to cover more of the module, the louvers 200 should also preferably have a trapezoidal shape (filling the profile shown in the outer line 114 on the module of FIG. 2). The other constraint on the clearance around the louver assembly is the shape of the free-blown dome 120. The shape of the dome 120 is determined by the temperature profile of the material and the speed and sequencing of the vacuum draw cycles. It is possible to more precisely control the contour of the dome 120 around the edges by using a partial molding tool, which can enforce the desired vertical clearance needed to bring the louvers closer to the edge of the south face.

With reference to both FIGS. 1 and 2, the figures show the top level assembly of a skylight module 100 according to certain aspects of an embodiment of the invention. The four subassemblies are the curb 112, the monitor 116, the louver assembly 220 (comprised of multiple louvers 200, and also referred to as the energy conversion module (ECM)), and the dome 120. Each subassembly is preferably fabricated offsite and delivered to the building site. Each part is designed for efficient transportation, lifting to the roof, and installation.

As noted above, the first component is a curb 112 that is mounted over an opening that is cut into an existing roof or formed in new construction. The curb 112 is preferably delivered to the site in four separate pieces and assembled on site.

Next, the monitor 116 (skylight) provides 1) structural support to the energy conversion module/louver assembly 220 (ECM), 2) thermal insulation between inside air and the outside, and 3) direction and diffusion for the light from the sky into the space below.

Next, the ECM 220, mounted on the south face of the monitor 116 (assuming the south face is facing the sun), is a micro-concentrating thermal collector and light managing device. A controller board 130 and a small electric stepper motor 132 control the angle of the louvers 200 to deliver the desired amount of light through the ECM 220, while converting the excess light to high grade thermal heat. Fluid lines 134 circulate coolant directly through each louver 200 to pipes located on the roof or in the ceiling space below the skylight modules 100.

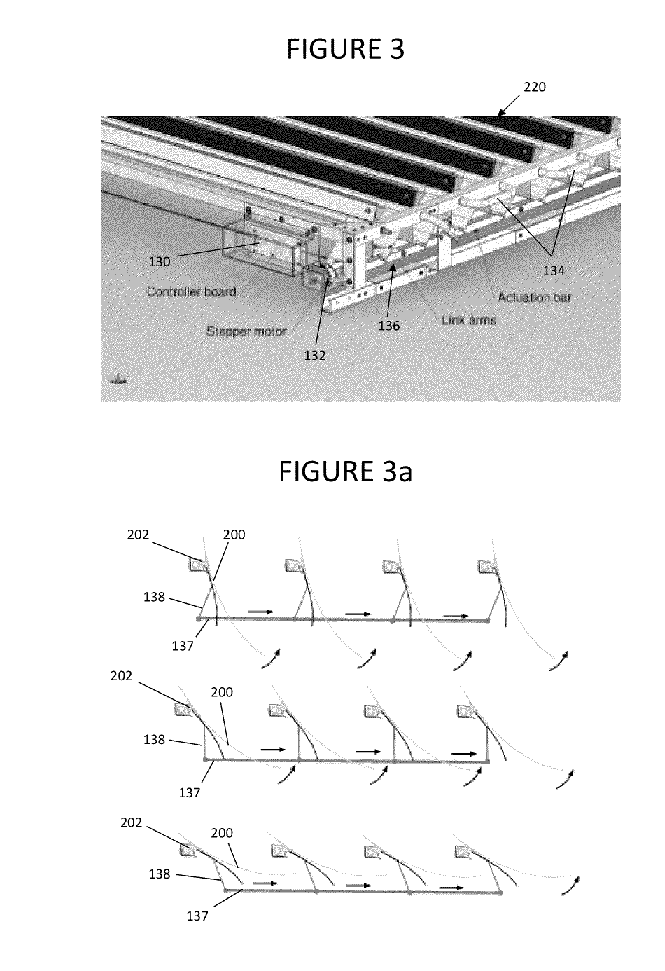

The louvers 200 are moved by stepper motor 132 and linkage 136 which is located on, for example, the west end of the ECM 220. The controller board 130 is preferably connected to a central control unit and sends commands to the stepper motor 132 which is connected to an actuation bar 131 of linkage 136. The actuation bar 137 is joined to each louver 200 by link arms 138 that connect preferably to the last inch of the west end of the louver 200. The action of the linkage is shown in the schematic views of FIG. 3a with a cross section of four louvers. The actuation bar 137 moves left to right with a small vertical component as the link arms 138 swing in a circular motion as the louver 200 pivots around a slot pivot 202 on the back of each receiver tube. Notably, the receiver tubes do not articulate. This allows for fixed fluid connections to the fluid lines 134 that connect the thermal receivers, an improvement from prior designs that required dynamic fluid seals between the receiver tubes and the fixed fluid tubes.

FIG. 4 shows cross sections of two louver sections to show additional detail. The mirror 204 of louver 200 can be either continuously curved or have a faceted shape. The facets are much easier to fabricate with simple sheet bending equipment; the continuously curved design requires custom tooling and high-force hydraulic presses to fabricate. The radius of curvature of the mirror 204 varies along its length to optimize the focusing of light on the thermal receiver 300 and secondary reflecting surfaces (described in greater detail below). As shown in the light path diagrams discussed below, the portion of the mirror 204 near the top is generally farther away from the adjacent receiver/reflector surfaces and so requires a larger radius of curvature (less curved shape). The portion of the mirror 204 near the bottom is generally presented with a shorter distance to the adjacent receiver and so requires a smaller radius of curvature to focus the light. The mirror 204 is attached to a pivot bar 206 that runs the length of the mirror 204 (or alternatively may consist of short sections to reduce thermal conductivity and losses). The pivot bar 206 has a linear bulb that fits into a slot 208 on the back of the receiver tube 300 to provide a pivot point for rotation. It is important to minimize the thermal conductivity between the hot receiver tube 300 and the mirrors 204 to keep the mirrors 204 from becoming cooling fins. Therefore, the pivot bar 206 is preferably attached to the mirror 204 with silicone foam tape which has a low thermal conductivity but can withstand the high temperatures of the thermal receiver 300. In addition, the outer surface of the linear bulb may be coated with Teflon or other high-temperature insulating plastic to minimize thermal conduction from the thermal receiver tube 300 to the pivot bar 206.

As best shown in FIG. 4, also attached to the pivot bar 206 is the reflecting diffuser 222. The reflecting diffuser 222 directs the rays of sunlight that strike it into the space below. The reflecting diffuser 222 (as well as the secondary mirror on the thermal receiver tube 300, discussed below) is made of specialty lighting reflector sheet that is partially specular and partially diffuse. Such specialty lighting reflector sheet material is readily commercially available, and may comprise, by way of non-limiting example, ALANOD 610G3 available from ALANOD GMBH & CO. KG, or ACA 420AE/DG available from ALUMINUM COIL ANODIZING CORP. The material reflects incoming light rays into a 20 degree cone which provides more diffuse projection into the space below while maintaining the directionality of the light. A purely diffuse reflector, such as a white painted surface, while providing soft light to the space below, would waste light by reflecting some of it back towards the primary mirror. A purely specular reflector, such as a polished reflector, would direct all of the light efficiently into the space, but would require secondary conditioning to avoid harsh glare spots. The shape of the reflecting diffuser 222 can either be curved, as shown in FIG. 4, or straight, as shown in the light path diagrams discussed in greater detail below. The main criteria in configuring the reflecting diffuser 222 is that the reflecting diffuser intercept preferably all light rays that come from the primary mirror 204 at the shallow angle so that they do not get re-reflected back to the primary mirror 204 and lost.

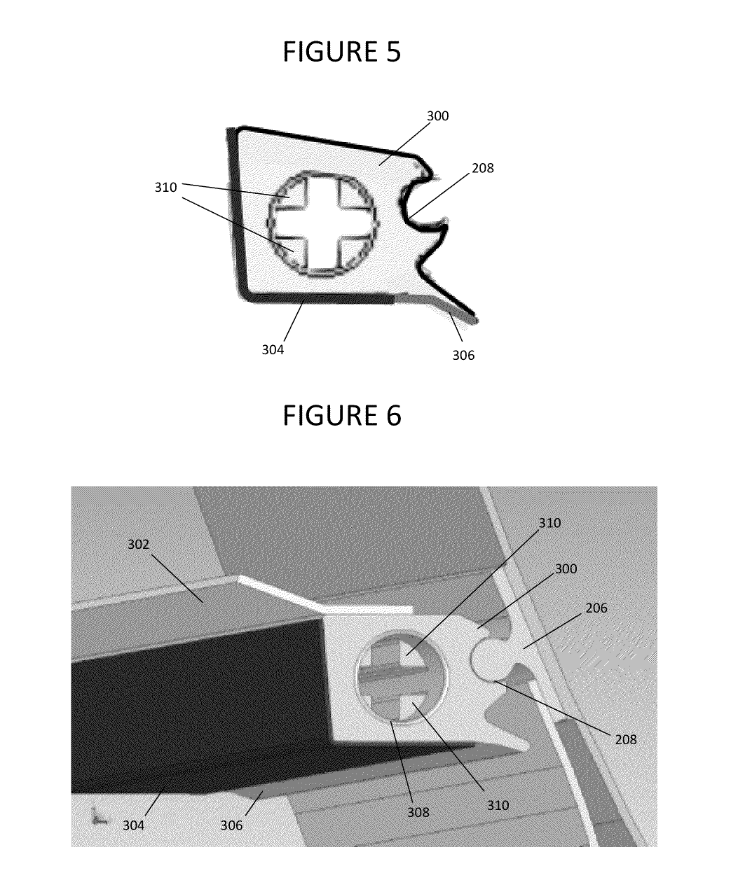

The details of the thermal receiver tube 300 are displayed in the cross-sectional views of FIGS. 5 and 6. The main body of the thermal receiver 300 is preferably formed of extruded aluminum. To the base extrusion, three features are attached using high-temperature epoxy adhesives: a thermal baffle 302, a thermal collector 304, and a secondary mirror 306. Also, the ends of the tube are reamed to close circular tolerance as discussed below.

The thermal collector 304 on the left and bottom of thermal receiver tube 300 are high-absorbing, low-emissivity thermally selective surfaces. These are formed from thin strips of optically treated aluminum sheets that are formed in a bending brake and adhered to the extrusion using high-conductivity epoxy adhesive. Such optically treated aluminum sheets are commercially available, and may comprise, by way of non-limiting example, ALANOD MIROTHERM available from ALANOD GMBH & CO. KG. These surfaces efficiently convert incoming full spectrum sunlight into thermal heat to be conducted through the wall of the thermal receive tube 300 and to the fluid circulating through the tube center passage 308. The secondary mirror 306 is positioned to the right of thermal collector 304 (as viewed in FIGS. 5 and 6), and comprises a diffusing reflector surface with optical properties similar to the reflecting diffuser 222. Such optical properties may be provided through application of a diffuse reflective paint, such as (by way of non-limiting example) LO/MIT coating available from SOLEC SOLAR ENERGY CORPORATION. The secondary mirror 306 is faceted as well, with a small horizontal section on the left and a longer section that is angled roughly 30 degrees downward. As will be seen in the light path diagrams discussed below, the horizontal section of secondary mirror 306 is designed to reflect light that comes towards the mirror from below, while the longer sloped section of secondary mirror 306 reflects rays that come from the left (again as viewed in FIGS. 5 and 6). Other features of the thermal receiver tube 300 include the linear slot 208 across the back that accepts the pivot bar 206 and the optional thermal baffle 302 on the top. The thermal baffle 302 traps a portion of the heat that escapes from the receiver surfaces to improve the thermal efficiency of the collecting surface. (Depending on the geometry, the thermal baffle 302 may block incoming sunlight, so the baffle may not be included and is not shown in all figures here.) The horizontal surface of the baffle 302 tends to slow the upward natural convection flow of air that causes heat from the receiver surface to be lost to the air inside the skylight module 100. The baffle 302 also serves to block radiant heat going directly from the receiver surface to the dome 120. The top of the baffle 302 is preferably painted with either an insulating paint that reduces convection losses, or with a metallic paint with a low emissivity that reduces radiant losses. Internal to the fluid tube 308, interiorly directed surfaces 310 are provided, creating a non-circular contour designed to increase the heat transfer surface area and to encourage turbulent flow which improves the heat transfer efficiency. Also, the ends of the tubes 308 are reamed to a close tolerance of about 0.001″. This allows the connecting fluid tubes to be attached using a technique known in the art as shrink fitting, where the tube to be inserted is chilled to about 100 F below the temperature of the outer tube. When the inner tube and outer tube come to equilibrium temperature, the inner tube expands and forms a tight seal with no adhesives or mechanical fasteners required.

The nature of optical systems is that the basic functionality of the system can be independent of scale. That is, the system can be photographically expanded or shrunk over a wide range and the system performs optically the same. The desired dimensions are a factor of the system cost and the fluid system performance (tube dimensions).

While the overall dimensions can have a great deal of variability, the relative sizes of the optical components have a much smaller envelope of allowable values. This being the case, one primary dimension has been selected as the variable that determines the overall scale—the distance between the centerlines of the receiver tubes 300, referred to as the pitch. Other dimensions can be expressed as a ratio to this overall parameter.

Optimal values and dimensional ranges for the critical dimensions are shown below.

| Dimension | Minimum | | Optimal | | Maximum | | Discussion |
|---|---|---|---|---|---|---|---|
| Pitch (absolute length | 50 | mm | 145 | mm | 300 | mm | Small pitch values result in small feature sizes and |
| in mm) | | | | | | | increased manufacturing costs. Large pitch results |
| | | | | | | | in wide mirror chords which lose stiffness and |
| | | | | | | | accuracy. |
| Mirror width | 1.469 | | 1.469 | | 1.476 | | Shorter mirror length allows direct sunlight to pass |
| (Dimensionless width | | | | | | | directly through under high sun conditions, |
| relative to louver | | | | | | | creating glare and reducing thermal capacity. |
| pitch) | | | | | | | Longer mirror lengths reduce lighting energy flux |
| | | | | | | | at high sun angles. |
| Thermal receiver width | 0.095 | | 0.1 | | 0.12 | | Smaller thermal receiver will not be able to |
| (Dimensionless width/ | | | | | | | capture the light. Larger receiver width reduces |
| pitch: Total length | | | | | | | thermal efficiency and increases cost and weight. |
| for horizontal and | | | | | | | The 0.1 ratio of receiver to aperture (pitch) sets the |
| vertical segments | | | | | | | concentration ratio at about 10. |
| Secondary mirror | 0.04 | | 0.041 | | 0.06 | | Secondary mirror cannot be much smaller and still |
| width (Dimensionless | | | | | | | redirect light as intended. Could be much longer |
| width/pitch) | | | | | | | with little effect except loss of thermal efficiency |
| | | | | | | | by adding hot area. |
| Secondary mirror | 165 | degrees | 155 | degrees | 145 | degrees | This is the internal angle of the two facets of the |
| internal angle | | | | | | | secondary mirror. Too small of an internal angle |
| | | | | | | | will direct the light back on to the primary mirror. |
| | | | | | | | Too large and the light will spill onto the diffusing |
| | | | | | | | reflector. |

| | | | | |
|---|---|---|---|---|
| Reflecting diffuser | 0.70 | 0.75 | 1.25 | If the reflecting diffuser is too short, it will allow |
| length/Pitch | | | | undiffused sunlight off the primary mirror into the |
| | | | | space below, causing glare. It can be much longer |
| | | | | with little effect until it is as long as the mirror. |

The mirror 204 is a non-imaging, variable geometry optical element. Its purpose is to focus incoming solar energy onto thermal absorbing and light reflecting elements on an adjacent louver in order to provide controlled illumination to the space below while efficiently harvesting excess sunlight as thermal heat. For a system operating in the mid-latitudes of the continental US, the articulating mirror system preferably operates over a 100 degree acceptance angle—from the sun at the horizon to 10 degrees north of zenith. For a given position of the sun, the angle of the mirror can be changed to move the focus area of the sunlight to vary the fraction of sunlight that is given to heating or light. Over the wide range of sun angles, it is not possible to have an arbitrary allocation of light and heat. The design goal is to provide up to 50% of the energy as lighting, and up to 100% as heating. At these levels, it will be possible to deliver 200 foot-candles of illumination to the space below, double the typical expected level.

The baseline mirror shape may be faceted for ease of manufacture. In this case, a long rectangular blank of mirrored aluminum sheet is formed into the desired mirror shape in a series of small bends performed by a precision controlled bending brake. Because the concentration of the reflector is a function of the width of the facet, the facet width of the facets is kept as small as possible, in this case preferably 0.25 inches. The bending angle at the vertices of the mirror shape was calculated from the desired radius of curvature along the length of the mirror 204.

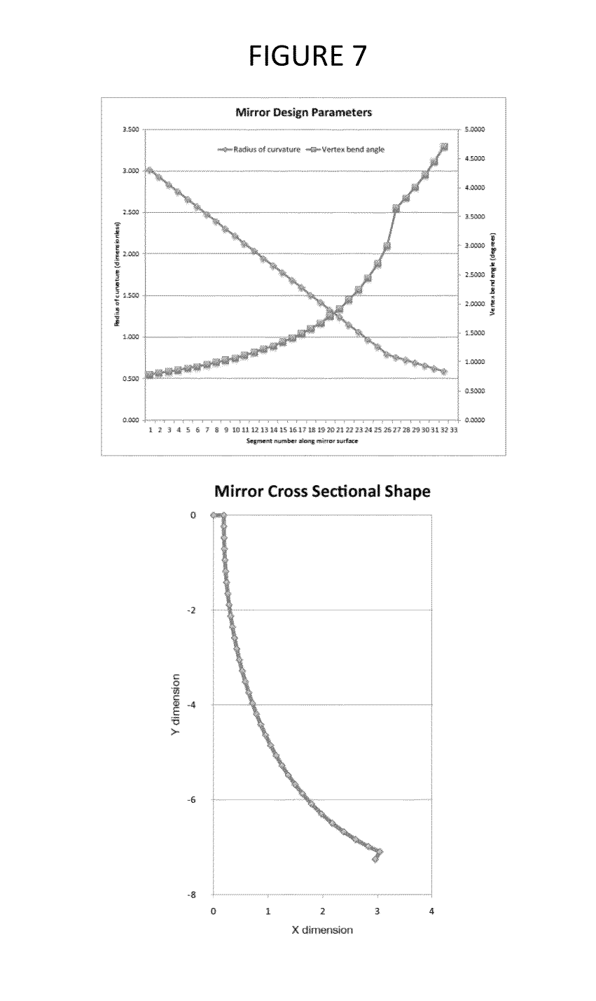

The top of mirror 204 is farther from the thermal receiver tube 300 and so has a larger radius of curvature, and the radius decreases linearly along the width of the mirror. There is a discontinuity in the curve as mirror 204 approaches the bottom; this was determined by analysis to be the optimal shape. FIG. 7 provides graphs showing relevant design parameters for the mirrors.

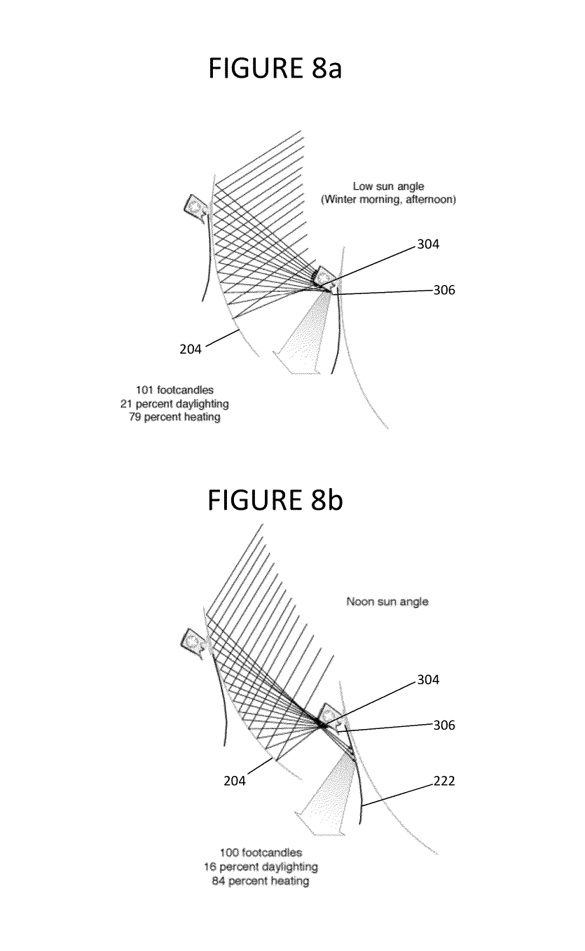

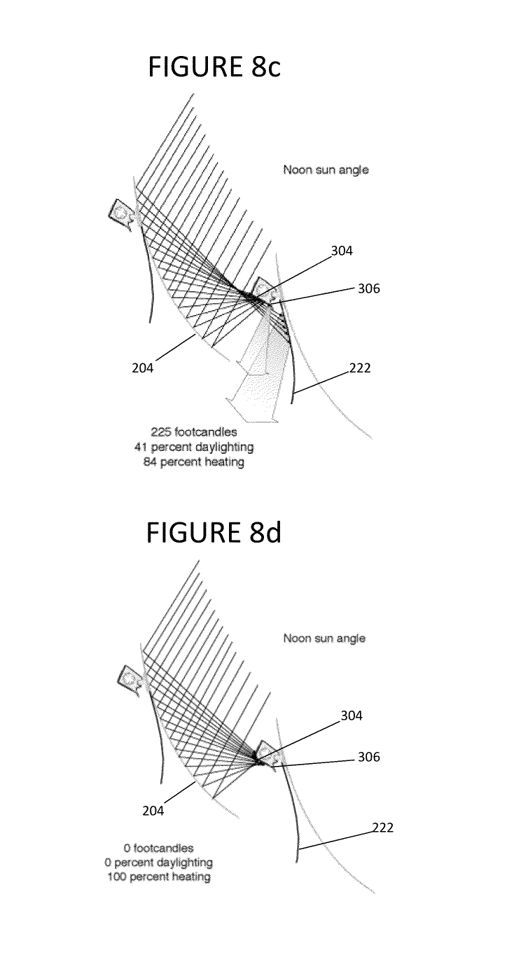

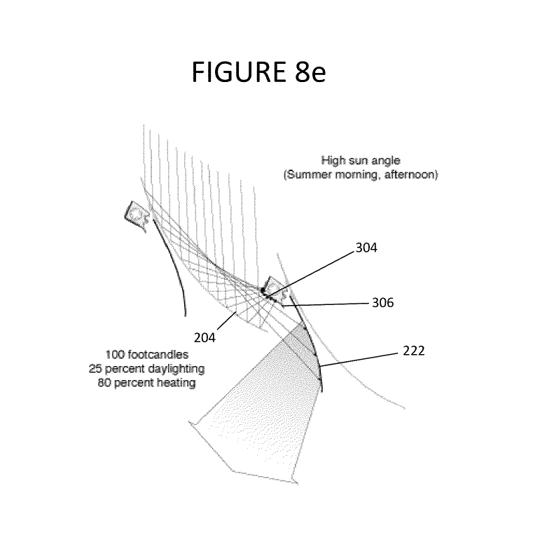

The path that light travels through the skylight module 100 varies with the position of the sun, the geometry of the louvers, and the degree of lighting desired at that time. The diagrams of FIG. 8 describe the light path for five commonly occurring conditions. With regard to the diagrams if FIG. 8, it is noted that they only show the path of the direct solar radiation through the optics. While not separately shown in FIG. 8, diffuse radiation also passes through the louvers and contributes a significant portion of the lighting delivered by the skylight module 100 overall. Also, while there are conditions where the skylight module 100 is configured for 100% heat collection, there is no provision for 100% light transmission, as this would provide over 300 foot-candles and would generate excessive heating. The system is designed to provide up to 50% of solar power as lighting.

FIG. 8a shows the light path diagram for a low sun angle. This condition occurs in early morning or late afternoon, especially in the winter when the sun is low to the horizon. The light for heating is focused mainly on the vertical section of thermal collector 304, while the lighting energy spills below the thermal receiver onto secondary mirror 306. The reflection from secondary mirror 306 goes downwards and is represented by a wide arrow to signify the 20 degree cone-shaped reflection from the part specular/part diffuse reflector of secondary mirror 306.

FIG. 8b shows the light path diagram for a mid-sun angle. This is the orientation that occurs most commonly and is the one that corresponds with the maximum available solar energy. The light that comes off of primary mirror 204 is at higher angle compared to the low sun angle. Therefore, the sun for lighting also spills off the bottom of the thermal collector 304, but is at such an angle that it misses the secondary mirror 306 and strikes the reflecting diffuser 222 directly. The reflecting diffuser 222 also reflects the light into a cone pattern to the space below. Note the rays that spill over for daylighting are the ones that come from the highest downward angle onto the reflecting diffuser 222. The curvature of mirror 204 was designed to do this so that the delivery of light into the space below would be the most efficient.

FIG. 8c shows the light path diagram again for a mid-sun angle and providing additional daylighting. The diagram shows a different angle of mirror 204 from FIG. 8b, which is intended to deliver more light and less heat. Mirror 204 is rotated clockwise by just a few tenths of a degree to direct more light onto secondary mirror 306 and reflecting diffuser 222.

FIG. 8d shows the light path diagram again for a mid-sun angle and providing no daylighting. In this orientation of mirrors 204, the light is directed more upwards so that 100% of the incoming direct solar energy can be delivered as heat.

FIG. 8e shows the light path diagram for a high sun angle. This geometry is similar to the mid-sun angle case. The daylighting rays come from the top of the primary mirror 204 at a high angle to the reflecting diffuser 222 and down below.

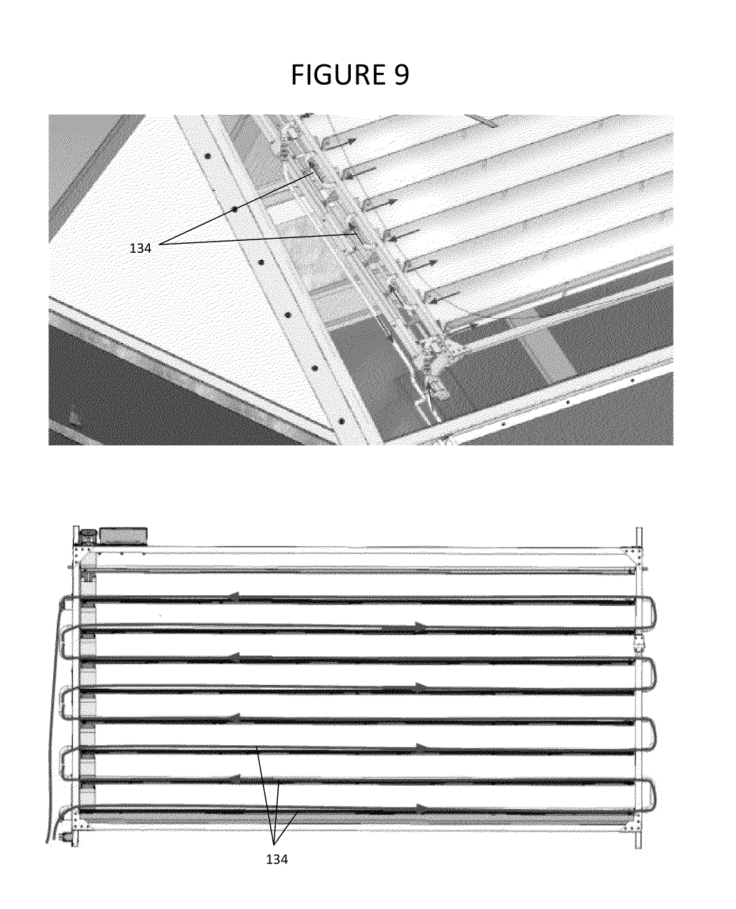

As mentioned above, the skylight modules 100 provide a fluid heat transfer system that transfers heat from the louvers 200 to a fluid carried through a fluid channel. Interiorly directed surfaces 310 form heat transfer grooves on the inside of the thermal receiver tube center passage 308 (as shown particularly in FIG. 4), increasing the surface area available for heat transfer and promote turbulent flow and consequently reduce the temperature gradient from the tube wall to the fluid. Likewise, the use of a fixed thermal receiver tube 300 as described herein (thus articulating the mirror elements only) avoids the need for seals able to accommodate rotating joints, and instead provides a construction that allows the load on the motor 132 and drive mechanism to be reduced by 75 percent over prior constructions (avoiding the need to overcome the high frictional forces that would otherwise be present with fluidly sealed rotating joints), improving actuation speed and long-term reliability, and allowing cost savings in the motor 132, linkage 136, drive electronics and rooftop wiring. A representative flow path of fluid through the skylight module 100 is shown in FIG. 9. The most important characteristic of the flow pattern is that the flow is serpentine and goes through each thermal receiver tube 300 sequentially. If the flow were parallel, the velocity in the tubes would be very small and heat transfer coefficients too low for efficient heat transfer. The flow is shown as starting at the bottom and flowing upwards; this could be reversed with no effect. The skylight modules 100 are preferably all connected in parallel to the rooftop piping system that draws the heat to storage tanks

In some configurations, the skylight module 100 may employ the area around the perimeter of the louver assembly to provide daylight to the space below when the louver assembly is in tracking mode. In this embodiment, two types of acrylic diffusers are preferably stacked and adhered to the south face of the skylight monitor 100 under the dome 120. The diffuser on top is a prismatic diffuser that breaks the light up in two dimensions to form a cone of light with about a 15 degree half angle. The bottom diffuser is a linear diffuser with deep sawtooth grooves that bifurcate the incoming light into two lobes each about 45 degrees from the angle of the incident light. The grooves are oriented in a north/south direction which spreads the light coming from each module strongly in an east/west direction. Sheets of such acrylic diffuser materials are readily commercially available, and may comprise, by way of non-limiting example, KSH-25 acrylic lighting panels available from PLASKOLITE, INC. This accomplishes two desired objectives. First, the intensity of the light coming to the area directly below the skylight module 100 is reduced, which eliminates uncomfortable glare that is ordinarily experienced directly under a typical diffusing skylight. Second, spreading the light east/west fills in the troughs of light that exist in the space between the rows of skylights, providing a much more even illumination on the work plane of the space below. However, one disadvantage of using this bidirectional lens is that some of the light is lost as it is directed onto other interior surfaces of the skylight. For example, the diffuser on the east side of the skylight module 100 forms two lobes of light directed to the east and west at 45 degree angles. The lobe that is directed to the west has a good view angle to the floor of the space below and this light is efficiently directed. However, a large fraction of the lobe directed to the east strikes the east wall of the skylight module 100 and either exits to the outside or is lost in re-reflections. In addition, to provide more controllability of the light, it is desired that the louver assembly cover a larger proportion of the south wall of the skylight module 100. This leaves less area available for the diffusing elements, so they must be made more efficient to deliver the same amount of light.

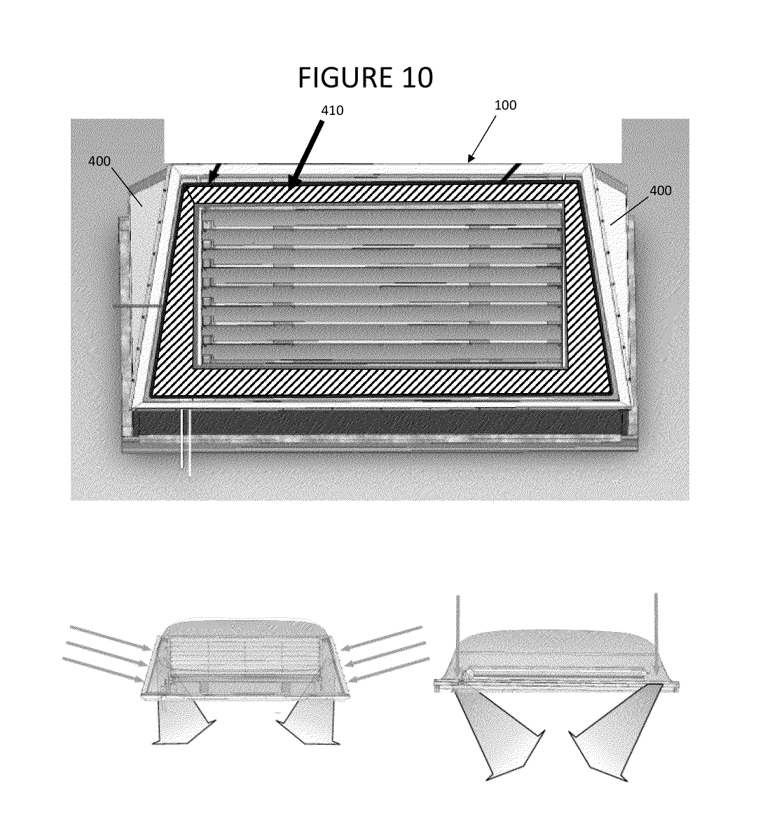

Alternatively, a combined directing/diffusing acrylic Fresnel lens can be used that has a unidirectional refracting lens on one side and a random or prismatic diffusing pattern on the other. To keep the tooling cost down for this custom optical material, the lenses can be fabricated in small sections about one foot square and the sections adhered to the south wall of the monitor to direct the incoming light to the most advantageous direction, minimizing losses and glare. Suitable materials for use as such optical material are readily commercially available, and may comprise, by way of non-limiting example, 36/55 asymmetrical prism film available from MICROSHARP CORPORATION LIMITED. With particular reference to FIG. 10, the diffuser material 400 is likewise placed on the outer surface of the east and west sides of the skylight module 100. Once again, nondirectional diffusers in these locations spread light in all directions, which causes a significant portion of the light to be directed onto other inner surfaces of the skylight; the light is then lost, being transmitted back outside, so having directional diffusing elements is important to improve the efficiency of the light transfer, which improves effectiveness and ultimately cost. Sunlight reaching the east and west surfaces that has a significant horizontal component will be diffused and directed downward, into the space. The directed linear Fresnel lens will prevent the light from being diffused upwards towards the inner surface of the south face of the skylight module 100, where it is transmitted out of the module back to the sky. Additionally, the diffuser material 400 will preferably be placed on the south face of the monitor, in the area indicated by arrow 410. The diffuser on the east side of the skylight module 100 will be oriented so that the light is directed towards the west, and vice versa. This will provide for good spreading of the light into the space, and most importantly, keep the light from passing through the east and west faces of the skylight module 100, and back outside.

The multiwall sheets described above have an ability to partially scatter the incoming light in one direction; additional sheets of diffusing and directing films are needed to evenly distribute the light and eliminate glare. The most straightforward method to add diffusing sheets to the panels would be to affix additional sheets to the inner or outer face of the multiwall sheets, but there are certain disadvantages of this approach. Few commercially available diffusing films are made of plastics that can withstand ultraviolet light. Further, the adhesive that holds the sheets on should be optically clear so as not to attenuate the light passing through it, and, if on the outer face, should withstand weather. Finally, laminating adhesives generally require several hundred pounds per square inch to activate, which can deform the multiwall panels.

An alternative approach is to cut the diffusing sheets into thin strips and insert them into the cells of the polycarbonate. The outer face of the polycarbonate panels is infused with a UV blocking compound to protect the polycarbonate from damaging effects of UV rays. Further, the polycarbonate itself is opaque to UV. Thus, the spaces between the ribs of the multiple walls is protected from UV radiation, and so lower cost plastics such as PET can be employed for the diffusing materials. Further, the narrow width of the cells allows the strips to stand in the cell with no adhesive required, thereby eliminating the cost and light attenuation of the adhesive.

Diffusing strips placed inside the multiwall sheets have the ability to almost totally attenuate the multiwall sheet's characteristic one-dimensional scattering of light. Previously, the one-dimensional scattering of the multiple internal reflections inside the multiwall polycarbonate matrix was described. This is often a desirable feature to scatter direct sunlight if there is something to scatter the light in the orthogonal axis. However, this natural scattering of the multiwall is sometimes undesirable. For example, the north wall of the skylight module 100 only receives direct sunlight in the early morning and late afternoon in the spring and summer. The one-dimensional scattering of this light creates glare spots during these periods since all of the direct sunlight is directed into a circular beam emanating from the panel. Diffusing sheets placed on the outer faces of the panels can somewhat diffuse the light coming from these internal reflections, but do nothing to attenuate the cause of the glare, which is the internal reflections themselves. This is because the light passes through the diffusing sheet only one time—on the way in or on the way out. Due to the multiple internal reflections in the multiwall sheets, light passes through the diffusing strips placed inside the matrix of plastic cells multiple times, multiplying their effectiveness and providing much more attenuation of the one-dimensional scattering compared to diffusing sheets placed on the inner or outer surfaces.

In order to increase strength and thermal insulation, multiwall panels preferably have three to five cavities. This provides the opportunity to employ multiple types of diffusers in series for different desired diffusing effects. For example, the east and west walls of the skylight module 100 must both diffuse and direct incoming horizontal or low-angle light downward into the space. For this application, diffusing strips may be placed in the outermost cell (towards the light source), and strips of a light-directing prismatic sheet may be placed in the innermost cell (towards the inner space). For good two-dimensional scattering, two strips of prismatic lenses may be cut at orthogonal angles and placed in series, one diffusing in a horizontal direction and one in a vertical direction. Alternatively, these orthogonally cut strips may be alternated or blended to achieve non-symmetric diffusing patterns. For example, if two thirds of the strips are cut to as to scatter horizontally, and one third to scatter vertically, a cone-shaped diffusing pattern may be achieved.

Central to the skylight module 100 is a low cost smart controller board 130 that is housed in each module that manages the angle of the louvers. The key control inputs are:
Mode of the building heating/cooling system.
Desired room illumination level.
Actual room illumination level.
   The desired room illumination level is determined by a time of day/day of week clock combined with real time inputs of a manual light switch or occupancy sensor. The first control objective is to achieve the desired illumination level. Early or late in the day or during cloudy periods, the louvers will be fully open to allow the full diffuse sky radiation to enter the building. As the sunlight increases, and the illumination level is above the set point, the louvers 200 are rotated counter clockwise (in the views of FIG. 8) to provide less daylight and more thermal heating. This control scheme makes it unnecessary to know the details of the sky conditions or the position of the sun in the sky. Only the actual light delivered is needed.

If the space below the skylight module 100 is unoccupied, it is possible that the illumination setpoint level would be zero. That is, the module would be in 100% heating mode. In this case, it is necessary to know the position of the sun in the sky and to know the amount of direct vs. diffuse solar radiation to position the louvers 200. The module control system is hierarchical, with a central controller preferably overseeing the activity of individual controller boards 130 on each skylight module 110. There is great advantage to making each skylight module 100 as self-sufficient as possible regarding its data and control activities to reduce the complexity of communications and interaction between the central and distributed controllers. This is made challenging by the need to make the controllers very low cost, which implies limited memory and computing resources.

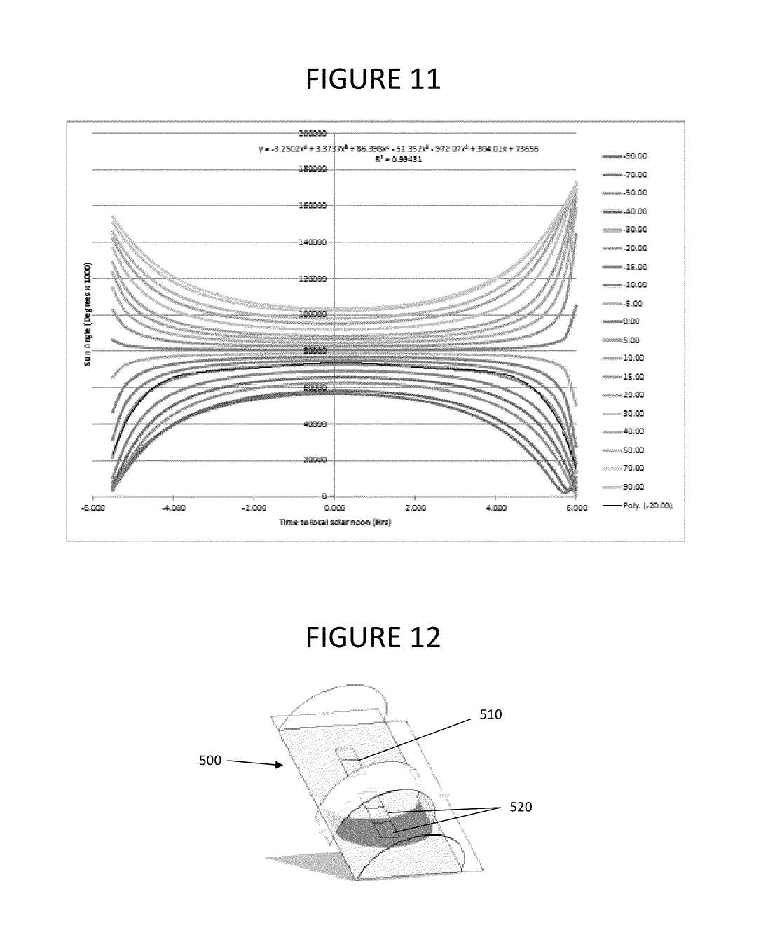

A software program provides the controller with knowledge of the sun position to within one tenth of a degree and uses less than 4k of memory and a negligible amount of computing cycles. The algorithm takes advantage of the fact that the modules require only single-axis tracking, so the only parameter of interest for the louver pointing is the angle of the sun incident on the skylight module 100 projected into a vertical north/south plane. Furthermore, for a particular location, (and east/west orientation of the module) this angle of interest follows a fairly well behaved set of curves depending on the time of year, as shown in FIG. 11. At the spring and fall equinox, the angle stays constant and does not change; at the solstices, it follows a smooth U-shaped curve. Each of the curves is converted into a 5th order polynomial approximation, with a set of coefficients for different days to the solar equinox. The controller can use the same set of coefficients for about 5 to 20 days, depending on the time of year. The calculation of the solar angle on the module then requires only the evaluation of a single 5th order polynomial every 1 to 2 minutes. This computation load is well within the capability of a simple microprocessor costing less than four dollars.

Another key parameter for controlling the daylight coming through the module is the incident solar radiation and the relative amounts of direct vs. diffuse light. Commercially available sensors employ a shadowing disk that is articulated to stay between a shadowed sensor and the solar disk. These are very accurate but prohibitively expensive to be deployed in renewable energy projects. To solve this problem, a low cost sensor is installed on each module that provides the necessary information to the controller on each module.

A drawing of the sensor 500 is shown in FIG. 12. The sky sensor 500 is mounted on the skylight module 100 at an elevation angle equal to the tilt angle of the modules. Four low cost light sensors are placed on a circuit board. The top most sensor 510 has a view of the whole sky and thus reads the total solar radiation level (direct plus diffuse). The three lower sensors 520 are placed such that at any one time, at least one of them is completely shadowed from the direct solar radiation and so that sensor has a reading that is an estimate of the diffuse radiation. Taking a difference between the full sky sensor 510 and the minimum reading from the three other sensors 520 provides an estimate of the direct solar beam radiation. The variability in reading from such a low cost optical sensors is relatively high (+/−25%). This is preferably accounted for by a one-time calibration of the sensor heads selected for each sensor assembly 500. The sensors are sufficiently low in cost that it is feasible to install one sensor assembly 500 on each skylight module 100 (as opposed to each system) so that local shadowing can be accounted for on each module. In the event of a failure of a sensor on one skylight module 100, or if two or more skylight modules 100 are expected to see identical shading environments, data from one sun sensor 500 may be shared with other sensors. The controller boards 130 of all the skylight modules 100 are connected to a single data bus, and the controller boards 130 on each skylight module 100 periodically transmit their data to the central controller. Because they are all connected on the same data bus, each controller has access to the data that is transmitted by every other controller. When a skylight module 100 needs to use another module's sensor data, it merely listens to the broadcast of sensor data from a list of controllers that it looks to in sequence for sun sensor data. No additional data transmission is needed for one of the controllers to use the data from another module's sensor.

It is also desirable to provide storage for the heat generated by the modules described above, and a thermal storage tank may be provided for this purpose. Moreover, partitioning and stratification for thermal storage of solar-generated heat is preferred. This is especially true of solar systems which drive absorption chilling equipment, because the solar heat is only useful above 160 F, and mixing of the hotter fluid that is returning from the solar collectors with cooler water in the storage tank creates entropy and degrades the utility of the heat. The ideal storage tank would approach perfect slug flow in a linear storage volume, with a hot end and a cold end. The cold end would supply the collectors with the coldest water, thereby achieving highest efficiency of the solar collection, and would return to the hot end. The hot end would supply the thermal loads, thereby achieving the best utility of the resource, and return to the cold end.

In order to make large commercial solar hot water systems practical and cost efficient, the cost of the thermal storage tanks must be kept within practical limits. Pressurized, welded steel tanks have the advantage of being able to be plumbed directly into the system piping, and are cost effective for smaller systems; however, large commercial solar thermal systems require tank sizes of several thousand up to 10 thousand gallons. Pressurized tanks at these sizes are not cost effective, and furthermore such large tanks are difficult to transport and install in existing buildings. An alternative storage tank technology makes use of unpressurized tanks that use a cylindrical foam insulation body with a riveted sheet metal skin to handle the hoop stress resulting from the hydrostatic pressure of the water in the tank. These tanks have a cost per unit volume of storage about one half to one third that of pressurized tanks, and have a practical height limit of about six feet. Unpressurized tanks also have the advantage of being shipped in flattened containers and assembled on site, which allows large tanks to be fit through doors and passageways to be installed in existing mechanical rooms.

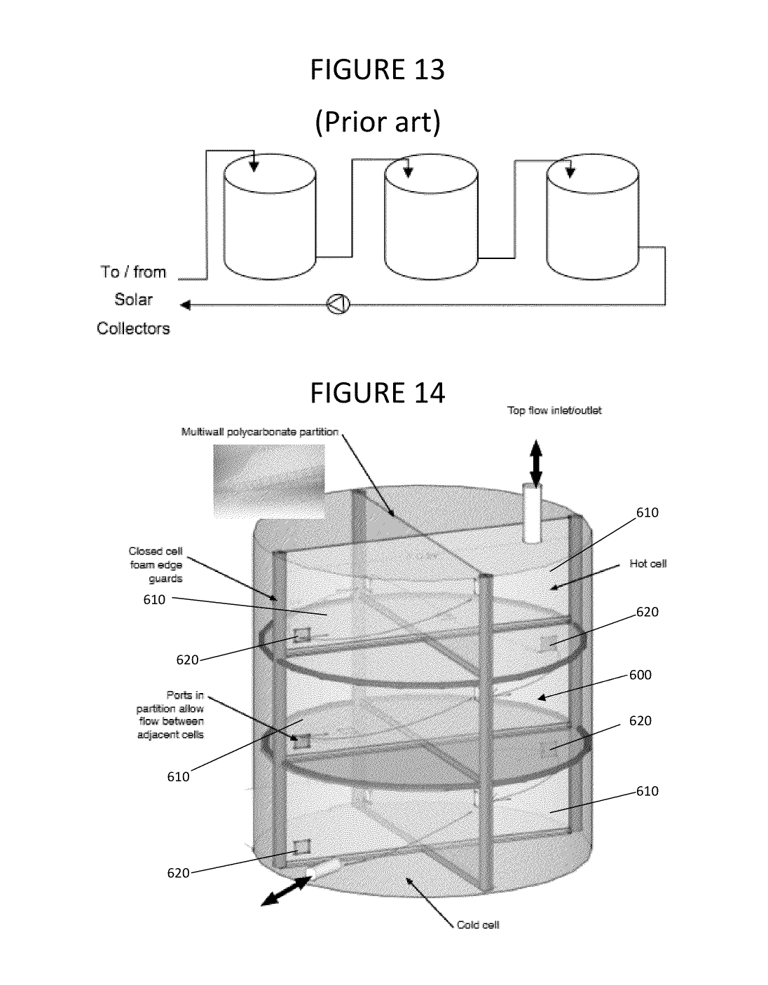

Thermal partitioning of the tank may be done using natural thermoclines, in which the buoyancy of the hotter water keeps it at the top of the column, while the colder water stays at the bottom. This approach, while simple, has several drawbacks. First, the velocity of the fluid flowing into the tank causes mixing in the vicinity of the inlet tube. This can be reduced by reducing the velocity at which the fluid enters the tank, and by making the flow direction horizontal so as not to inject water across the isotherms and directly causing mixing. However, at higher flowrates large diffusing nozzles are required to reduce the exit velocity enough to reduce mixing, and in any case some mixing is unavoidable. Second, in order to achieve good thermal separation, the tank must be tall to make the most use of gravity as the separator. This has two drawbacks. First, the additional height increases the hydrostatic pressure on the lower part of the tank walls. This is not an issue for pressurized metal tanks because the additional static pressure is small compared to the design pressure of the tank. However, as discussed above, low-cost unpressurized tanks have a height limit, and stratification of large tanks is problematic. For example, a 1500 gallon tank with a maximum height of six feet has a diameter of about 10 feet. This height/diameter ratio of 6:10 is the inverse of that which would yield good stratification. One prior art solution to this is to plumb several tanks in series, top to bottom, as shown in FIG. 13. This allows good stratification, but at a much greater tankage cost. Three tanks have twice the surface area of a single tank of the same total volume and aspect ratio. In conclusion, there is a need for a low cost, practical method for partitioning large unpressurized storage tanks

As shown in FIG. 14, a tank insert (shown generally at 600) can achieve an approximation of the desired slug flow by dividing the cylindrical tank into 12 separate chambers 610 with a very low cost design. The partitions are made of multi-wall polycarbonate which has the advantages of light weight, low cost, neutral buoyancy, good insulting properties, and a melting point at least 100 degrees higher than the boiling point of the water storage medium. The hot fluid enters through the top of the tank into one of the four upper level chambers 610. Small holes 620 in the vertical partitions allow the water to flow clockwise through the four upper chambers in series, and then a hole in the bottom of the fourth chamber directs flow to the middle layer.

The water flows through the four chambers 610 of the middle layer, then down and through the lower layer chambers. The fluid flow direction is opposite for flow to/from the thermal loads; the fluid is drawn out of the top and returns to the bottom chamber. Because the fluid volumes are positively separated by barriers, there is no restriction on the inlet velocity of the fluid, because mixing within one chamber has little loss of entropy. When there is no flow, it is beneficial for the fluid not to mix and for there to be little conduction or convection between cells. The openings 620 are kept small to reduce mixing, and because the hot cells are on top, there will be no upward mixing through the opening. Dynamic simulations have shown that 12 chambers 610 aligned in series provide a close approximation of classic slug flow, and little benefit is derived from increasing the number of chambers. However, if more chambers are desired for a larger tank, the number of partitions per layer could be increased by six or eight.

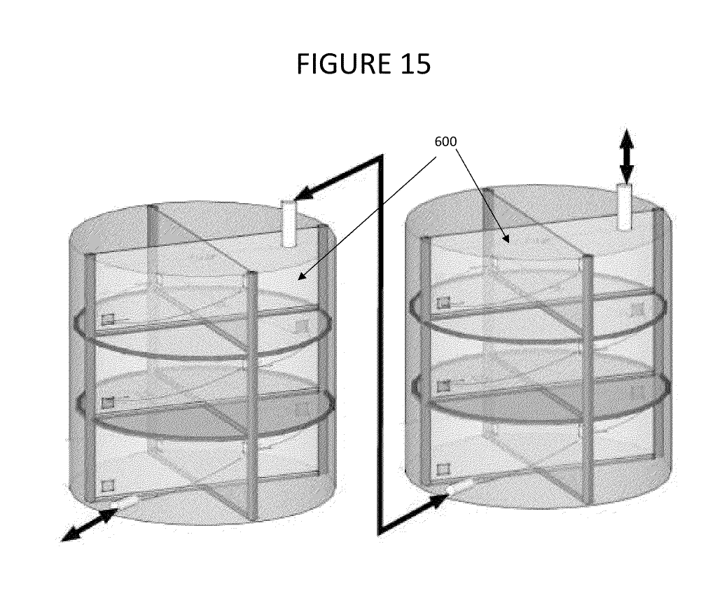

The largest practical size for an unpressurized storage tank is about 3000 gallons. If a system requires more storage than this, multiple tanks can be plumbed in series as shown in FIG. 15.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. An energy management system comprising:
a first louver having a front side;
a second louver having a back side and positioned adjacent said first louver such that said back side of said second louver faces said front side of said first louver;
a receiver tube attached to said back side of said second louver, said receiver tube having an outer surface comprising a thermal collector, and an interior fluid channel; and
a reflecting diffuser attached to said back side of said second louver;
wherein said front side of said first louver is configured to reflect sunlight impacting said front side of said first louver toward said back side of said second louver, said thermal collector is configured to convert at least a portion of said reflected sunlight into thermal heat and transfer said thermal heat to a working fluid within said interior fluid channel, and said reflecting diffuser is configured to reflect at least a portion of said reflected sunlight to a space below said first and second louvers.

2. The energy management system of claim 1, wherein said second louver is pivotably attached to said receiver tube.

3. The energy management system of claim 2, said second louver further comprising a pivot bar fixedly attached to said back side of said second louver.

4. The energy management system of claim 3, said pivot bar comprising a linear bulb positioned within a slot on said receiver tube so as to pivotably attach said second louver to said receiver tube.

5. The energy management system of claim 3, wherein said reflecting diffuser is fixedly attached to said pivot bar.

6. The energy management system of claim 3, wherein said pivot bar is attached to said second louver with a low thermally conductive adhesive.

7. The energy management system of claim 6, wherein said low thermally conductive adhesive comprises silicone foam tape.

8. The energy management system of claim 1, further comprising:
a skylight module containing said first louver and said second louver, wherein said receiver tube is fixedly attached to said module.

9. The energy management system of claim 8, wherein said module further comprises an actuation bar configured to pivot said first louver and said second louver in unison.

10. The energy management system of claim 8, said module further comprising a non-opaque housing covering said first and second louvers, at least a portion of said housing comprising a light diffuser assembly configured to diffuse a portion of light impacting said module and to direct said portion of light downward into a space below said module.

11. The energy management system of claim 1, wherein said first louver is curved and has a radius of curvature that varies along a lateral length of said first louver, and wherein said varying radius of curvature is configured to optimize focusing of light on said thermal collector and said reflecting diffuser on said second louver.

12. The energy management system of claim 1, said thermal collector further comprising a secondary mirror configured to reflect at least a portion of light impacting said thermal collector.

13. The energy management system of claim 12, wherein said secondary mirror comprises a horizontal first portion adjacent a bottom face of said thermal collector that is configured to reflect light that approaches said secondary mirror from below, and a second portion that is configured with a downward angle with respect to said first portion and configured to reflect light that comes from said first louver.

14. The energy management system of claim 1, said interior fluid channel of said thermal collector being provided a non-circular contour.

15. The energy management system of claim 14, wherein said non-circular contour is configured to increase heat transfer surface area within said interior fluid channel and to encourage turbulent flow within said interior fluid channel.

16. The energy management system of claim 1, further comprising:
a skylight module containing said first louver and said second louver; and
a controller, said controller having computer executable code configured to:
receive as input a desired mode of building temperature control of heating or cooling, a desired room illumination level, and an actual room illumination level; and
in response to said input, move said first and second louvers to adjust thermal collection and light reflection from and passage through said module.

17. The energy management system of claim 1, further comprising:
a skylight module containing said first louver and said second louver; and
a fluid distribution system in fluid communication with said skylight module, said fluid distribution system configured to carry a working fluid that is heated in said interior fluid channel from said skylight module to a thermal storage tank assembly.

18. The energy management system of claim 17, said thermal storage tank assembly further comprising partitions on an interior of said storage tank dividing said interior into multiple chambers and configured to cause fluid flow through said chambers from a highest temperature chamber to a lowest temperature chamber.

19. An energy management system comprising:
a skylight module;
a first louver having a front side and positioned within said skylight module;
a second louver having a back side and positioned adjacent said first louver within said skylight module such that said back side of said second louver faces said front side of said first louver; and
a receiver tube fixedly mounted within said skylight module, said receiver tube having an outer surface comprising a thermal collector, and an interior fluid channel, said second louver being pivotably attached to said receiver tube;
wherein said front side of said first louver is configured to reflect sunlight impacting said front side of said first louver toward said back side of said second louver, and said thermal collector is configured to convert at least a portion of said reflected sunlight into thermal heat and transfer said thermal heat to a working fluid within said interior fluid channel.

20. The energy management system of claim 19, further comprising:
a reflecting diffuser attached to said back side of said louver, wherein said reflecting diffuser is configured to reflect at least a portion of said reflected sunlight to a space below said first and second louvers.

21. The energy management system of claim 19, said second louver further comprising a pivot bar fixedly attached to said back side of said second louver.

22. The energy management system of claim 21, said pivot bar comprising a linear bulb positioned within a slot on said receiver tube so as to pivotably attach said second louver to said receiver tube.

23. The energy management system of claim 21, wherein said pivot bar is attached to said second louver with a low thermally conductive adhesive.

24. The energy management system of claim 23, wherein said low thermally conductive adhesive comprises silicone foam tape.

25. The energy management system of claim 19, wherein said module further comprises an actuation bar configured to pivot said first louver and said second louver in unison.

26. The energy management system of claim 19, said module further comprising a non-opaque housing covering said first and second louvers, at least a portion of said housing comprising a light diffuser assembly configured to diffuse a portion of light impacting said module and to direct said portion of light downward into a space below said module.

27. The energy management system of claim 19, wherein said first louver is curved and has a radius of curvature that varies along a lateral length of said first louver, and wherein said varying radius of curvature is configured to optimize focusing of light on said thermal collector and said reflecting diffuser on said second louver.

28. The energy management system of claim 19 said thermal collector further comprising a secondary mirror configured to reflect at least a portion of light impacting said thermal collector.

29. The energy management system of claim 28, wherein said secondary mirror comprises a horizontal first portion adjacent a bottom face of said thermal collector that is configured to reflect light that approaches said secondary mirror from below, and a second portion that is configured with a downward angle with respect to said first portion and configured to reflect light that comes from said first louver.

30. The energy management system of claim 19, said interior fluid channel of said thermal collector being provided a non-circular contour.

31. The energy management system of claim 30, wherein said non-circular contour is configured to increase heat transfer surface area within said interior fluid channel and to encourage turbulent flow within said interior fluid channel.

32. The energy management system of claim 19, further comprising:
a controller, said controller having computer executable code configured to:
receive as input a desired mode of building temperature control of heating or cooling, a desired room illumination level, and an actual room illumination level; and
in response to said input, move said first and second louvers to adjust thermal collection and light reflection from and passage through said module.

33. The energy management system of claim 19, further comprising:
a fluid distribution system in fluid communication with said skylight module, said fluid distribution system configured to carry a working fluid that is heated in said interior fluid channel from said skylight module to a thermal storage tank assembly.

34. The energy management system of claim 33, said thermal storage tank assembly further comprising partitions on an interior of said storage tank dividing said interior into multiple chambers and configured to cause fluid flow through said chambers from a highest temperature chamber to a lowest temperature chamber.
